(19) United States
(12) Patent Application Publication
(10) Pub. No.: US 2015/0067392 A1
(43) Pub. Date: Mar. 5, 2015

(54) CLOCK DATA RECOVERY DEVICE AND DISPLAY DEVICE INCLUDING THE SAME

(71) Applicant: Samsung Electronics Co., Ltd., Suwon-Si (KR)

(72) Inventors: Jung-pil LIM, Hwaseong-si (KR); Dong-Myung LEE, Yongin-si (KR)

(21) Appl. No.: 14/313,004

(22) Filed: Jun. 24, 2014

(30) Foreign Application Priority Data
Sep. 2, 2013 (KR) 10-2013-0105094

(51) Int. Cl. G06F 11/07; G06F 1/12

(52) U.S. Cl. CPC G06F 11/0793; G06F 1/12
USPC 714/15

(57) ABSTRACT

A clock data recovery device includes a clock recovery device for separating a recovery clock signal and a data signal from an input signal and generating a clock fail signal in response to noise of the input signal; a clock generator for receiving a control voltage to generate one or more delay clock signals, delaying the recovery clock signal to generate the delay clock signals in a first mode, delaying the generated delay clock signal to generate the delay clock signal in a second mode, and switching the first mode to the second mode in response to the clock fail signal; and a phase frequency detector for comparing at least one of the delay clock signals with the recovery clock signal to generate a voltage adjusting signal; and a control voltage generator for receiving the voltage adjusting signal to generate the control voltage.

### CROSS-REFERENCE TO RELATED APPLICATIONS

This application claims the benefit of Korean Patent Application No. 10-2013-0105094, filed on Sep. 2, 2013, in the Korean Intellectual Property Office, the disclosure of which is incorporated herein in its entirety by reference.

### BACKGROUND

Example embodiments of the inventive concepts relate to a clock data recovery device and a system, and more particularly, to a clock data recovery device including a clock generator for generating a clock signal regardless of noise.

As systems are developed to become highly integrated and operate at high speeds, transmission devices may utilize high-speed serial communication methods rather than parallel transmission methods. In general, standards used in high-speed serial communication methods, utilize a data transmission speed of several hundreds of bps to several giga bps. In addition, in the standards, data may be transmitted without transmitting an additional clock signal. However, when noise such as electro static discharge (ESD) is generated, an error may occur in a recovery operation of clock data received at a receiving device.

### SUMMARY

Example embodiments of the inventive concepts provide a clock data recovery device including a clock generator for generating a clock signal regardless of noise generated instantaneously.

According to an example embodiment of the inventive concepts, there is provided a clock data recovery device.

In one or more example embodiments, the clock data recovery device may include a clock recovery device configured to separate a recovery clock signal and a data signal from an input signal and generating a clock fail signal in response to noise of the input signal; a clock generator configured to receive a control voltage to generate one or more delay clock signals, delaying the recovery clock signal to generate the delay clock signals in a first mode, delaying the generated delay clock signal to generate the delay clock signal in a second mode, and switching the first mode to the second mode in response to the clock fail signal; and a phase frequency detector configured to compare at least one of the delay clock signals with the recovery clock signal to generate a voltage adjusting signal; and a control voltage generator configured to receive the voltage adjusting signal to generate the control voltage.

The clock generator may include: a delay unit configured to delay the recovery clock signal to generate a reference delay clock signal; a multiplexer configured to output one of the delay clock signals or the reference delay clock signal to a reference clock signal, in response to the clock fail signal; and a delay line configured to output the delay clock signals on the basis of the reference clock signal.

The clock generator may include: a delay unit configured to delay the recovery clock signal to generate a reference delay clock signal; a first delay line configured to delay the reference delay clock signal to output first preliminary delay clock signals; and a second delay line configured to delay one of the first preliminary delay clock signals to output second preliminary delay clock signals. The clock data recovery device may further include a multiplexer for outputting the first preliminary delay clock signals or second preliminary delay clock signals in response to the clock fail signal.

The clock recovery device may generate the clock fail signal with reference to the clock window signal generated by the clock generator.

The clock generator may generate a clock fall signal after the elapse of a fixed period of time from the reception of the clock fail signal, and the clock recovery device may receive the clock fall signal and toggles the clock fail signal.

At least one of the delay unit, the multiplexer, and the delay line may include at least one delay cell including a NAND gate.

The clock generator may include a plurality of delay cells including a NAND gate.

The delay clock signals may be output from some of the plurality of delay cells.

An input of the NAND gate included in any one of the plurality of delay cells may be a signal obtained by reversing the clock fail signal.

The clock fail signal may be received through one of input terminals of the NAND gates included in a last delay cell of the plurality of delay cells.

An output terminal of the NAND gate included in a last delay cell of the plurality of delay cells may be connected to an input terminal of the NAND gate included in any one of the plurality of delay cells.

The control voltage generator may include: a charge pump configured to receive the voltage adjusting signal and comparing the at least one delay clock signal and the recovery clock signal; and a loop filter configured to generate the control voltage through a difference value between the at least one delay clock signal and the recovery clock signal which is obtained by the charge pump.

According to another example embodiment of the inventive concepts, there is provided a display device.

In one or more example embodiments, the display device may include a timing controller configured to integrate a color data signal and clock signal which are to be displayed, to generate an input signal; a data driver configured to receive the input signal to generate a gradation voltage on the basis of the color data signal and the clock signal which are separated from the timing controller using a clock data recovery device; and a display panel configured to receive the gradation voltage from the data driver and outputting an image. The clock data recovery device includes: a clock recovery device configured to separate a recovery clock signal and a data signal from an input signal and generating a clock fail signal in response to noise of the input signal; a clock generator configured to receive a control voltage to generate one or more delay clock signals, delaying the recovery clock signal to generate the delay clock signals in a first mode, delaying the generated delay clock signal to generate the delay clock signal in a second mode, and switching the first mode to the second mode in response to the clock fail signal; and a phase frequency detector configured to compare at least one of the delay clock signals with the recovery clock signal to generate a voltage adjusting signal; and a control voltage generator configured to receive the voltage adjusting signal to generate the control voltage.

The clock generator may include: a delay unit configured to delay the recovery clock signal to generate a reference delay clock signal; a multiplexer configured to output one of the delay clock signals or the reference delay clock signal to a reference clock signal, in response to the clock fail signal; and a delay line configured to output the delay clock signals on the basis of the reference clock signal.

The clock generator may include a plurality of delay cells including a NAND gate.

At least one example embodiment relates to a clock data recovery device.

In at least one example embodiment, the clock data recovery device includes a clock recovery device configured to detect noise associated with an input signal and output a clock fail signal based on a result of the detection; and a clock generator configured to recover a clock signal by continuously feeding back a delayed clock signal in an internal feedback loop therein, if the clock fail signal indicates that the clock recovery device detects the noise.

In at least one example embodiment, the clock recovery device is further configured to separate the input signal into the clock signal and a data signal and detect the noise if a signal indicating a rising edge or falling edge of the clock signal does not toggle when the data signal is active. The clock data recovery device may thriller include a phase frequency detector configured to compare at least one of the delayed clock signals with the clock signal and generate an adjusting voltage based on a result of the comparison, an amount of delay included in the delayed clock signal varying based on the adjusting voltage.

In at least one example embodiment, the delayed clock signal is only utilized as the clock signal when the clock generator switches from a first mode to a second mode in response to the clock recovery device detecting the noise associated with the input signal.

In at least one example embodiment, the clock generator includes a delay unit configured to delay the clock signal to generate a reference clock signal; a multiplexer configured to output one of the clock signal and the reference clock signal; and a delay circuit configured to delay the clock signal based on the reference clock signal.

In at least one example embodiment, the delay circuit included in the clock generator includes a plurality of delay cells configured to output a delayed clock signal to a first input of a NAND gate in a next one of the plurality of delay cells, the NAND gates having a delay associated therewith, wherein a second input of the NAND gate in the plurality of delay cells is configured to receive the clock fail signal, and the NAND gate in a last one of the plurality of delay cells is configured to provide an output thereof to a preceding one of the plurality of delay cells to create the internal feedback loop.

### BRIEF DESCRIPTION OF THE DRAWINGS

Example embodiments of the inventive concepts will be more clearly understood from the following detailed description taken in conjunction with the accompanying drawings in which:

FIG. 1 is a block diagram of a display device according to an example embodiment of the inventive concepts;

FIG. 2 is a block diagram of a clock data recovery device according to an example embodiment of the inventive concepts;

FIG. 3 is a flowchart illustrating an operation of the clock data recovery device of FIG. 2;

FIG. 4 is a detailed block diagram of the clock data recovery device of FIG. 2;

FIG. 5 is a circuit diagram illustrating a clock generator according to an example embodiment of the inventive concepts;

FIG. 6 is a diagram illustrating a unit delay included in a clock generator according to an example embodiment of the inventive concepts;

FIGS. 7A and 7B are diagrams illustrating signals generated by a delay unit of FIG. 5;

FIG. 8 is a diagram illustrating a mode switching operation of unit delays included in the delay unit of FIG. 5;

FIG. 9 is a timing diagram illustrating an operation of a clock data recovery device according to an example embodiment of the inventive concepts;

FIG. 10 is a block diagram of a clock data recovery device according to another diagram according example embodiment of the inventive concepts;

FIG. 11 is a block diagram of a clock data recovery device according to another example embodiment of the inventive concepts;

FIG. 12 is a diagram illustrating a display module according to an example embodiment of the inventive concepts;

FIG. 13 is a diagram illustrating a display system according to an example embodiment of the inventive concepts; and

FIG. 14 is a diagram illustrating an application example of various electronic products to which a display device according to an example embodiment of the inventive concepts is mounted.

### DETAILED DESCRIPTION OF THE EMBODIMENTS

Example embodiments of the inventive concepts will now be described more fully with reference to the accompanying drawings, in which example embodiments of the inventive concepts are shown. The inventive concepts may, however, be embodied in many different forms by one of ordinary skill in the art without departing from the technical teaching of the inventive concepts. In other words, particular structural and functional description of the inventive concepts are provided in descriptive sense only; various changes in form and details may be made therein and thus should not be construed as being limited to the embodiments set forth herein. As the inventive concepts are not limited to the example embodiments described in the present description, and thus it should not be understood that the inventive concepts includes every kind of variation examples or alternative equivalents included in the spirit and scope of the inventive concepts.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which these inventive concepts belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. As used herein, the term “and/or” includes any and all combinations of one or more of the associated listed items. Expressions such as “at least one of” when preceding a list of elements, modify the entire list of elements and do not modify the individual elements of the list. Like reference numerals denote like elements throughout the specification.

Various example embodiments will now be described more fully with reference to the accompanying drawings in which some example embodiments are shown. In the drawings, the thicknesses of layers and regions are exaggerated for clarity.

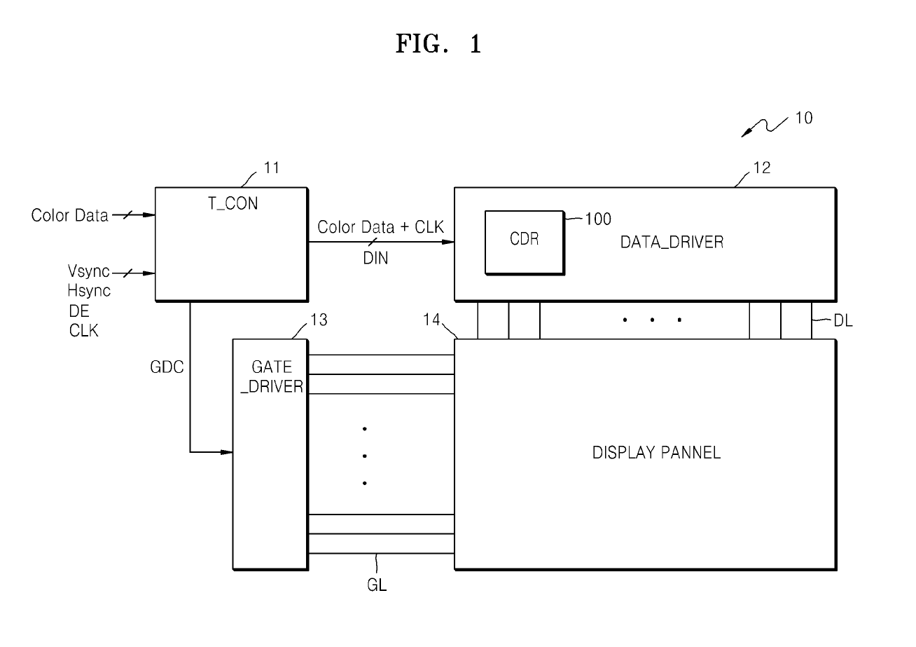

FIG. 1 is a block diagram of a display device according to an example embodiment of the inventive concepts.

Referring to FIG. 1, a display device 10 may include a display panel 14, a timing controller (T_CON) 11, a data driver (DATA_DRIVER) 12, and a gate driver (GATE_DRIVER) 13.

In the display panel 14, a plurality of data lines DL and a plurality of gate lines GL cross each other, and a pixel is disposed in each of display regions where the data lines DL and the gate lines GL cross each other.

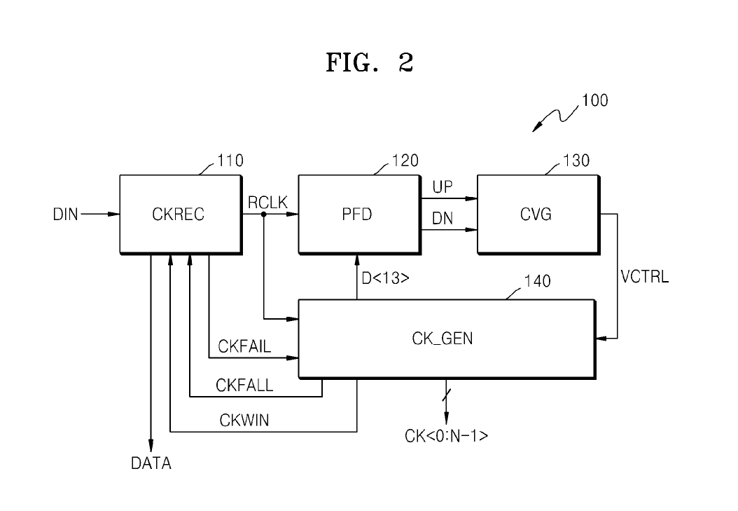

The data driver 12 includes a clock data recovery (CDR) device 100. The clock data recovery device 100 generates a plurality of delay clock signals CK<0:N−1> (see FIG. 2) and image data DATA (see FIG. 2) on the basis of an input signal DIN. The data driver 12 provides the image data synchronized with each of the delay clock signals to the display panel 14.

The gate driver 13 generates scan pulses under the control of the timing controller 11 and sequentially supplies the scan pulses to the gate lines GL to select a horizontal line through which a data voltage is to be applied.

The timing controller 11 may receive color data from the outside. The timing controller 11 may receive the color data from, for example, an internal storage device or a buffer.

The timing controller 11 generates the input signal DIN for controlling an operation timing of the data driver 12 and a gate control signal GDC for controlling an operation timing of the gate driver 13, on the basis of timing signals such as color data, a vertical synchronizing signal Vsync, a horizontal synchronizing signal Hsync, a clock signal CLK, and a data enable signal DE.

Even in a case of the inflow of instant noise such as electro static discharge (ESD) from the outside, the clock data recovery device 100 according to some example embodiments of the inventive concepts may normally generate clock data by continuously performing a clock data recovery operation using an internal loop on the basis of the previously generated clock signal. A detailed configuration and operation thereof will be described below.

FIG. 2 is a block diagram of the clock data recovery device 100 according to an example embodiment of the inventive concepts.

Referring to FIG. 2, the clock data recovery device 100 may include a clock recovery device (CKREC) 110, a phase frequency detector (PFD) 120, a control voltage generator (CVG) 130, and a clock generator (CK_GEN) 140.

The clock recovery device 110 receives the input signal DIN and separates a recovery clock signal RCLK and a data signal DATA. Although the input signal DIN is illustrated as a single signal in FIG. 2, the input signal DIN may be a differential signal.

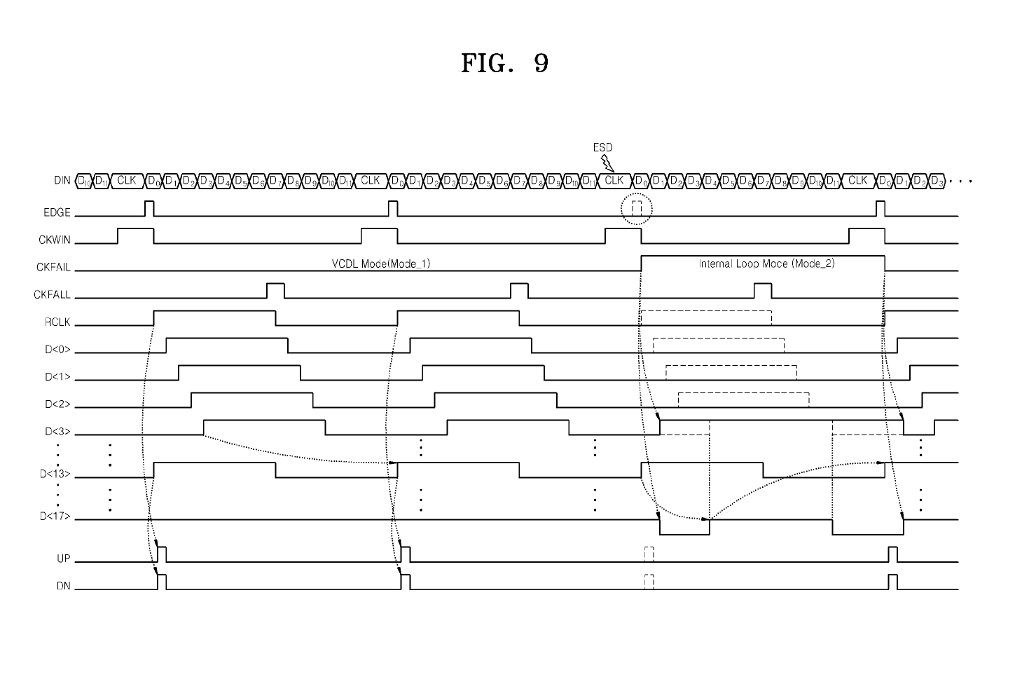

When instant noise such as ESD is inserted into the input signal DIN, the clock recovery device 110 may generate a clock fail signal CKFAIL. For example, when a clock window signal is in a high level during an active data period of the input signal DIN, if an edge signal EDGE (see FIG. 9) generated from the input signal DIN is not toggled, the clock recovery device 110 may determine that instant noise is generated.

The clock generator 140 may receive the recovery clock signal RCLK to generate the delay clock signals CK<0:N−1>.

The clock generator 140 may generate a clock fall signal CKFALL after the elapse of a fixed period of time from the reception of the clock fail signal CKFAIL. The clock recovery device 110 may generate the recovery clock signal RCLK again based on having received the clock hill signal CKFALL. The clock generator 140 may switch from a first mode to a second mode after the elapse of a period of time (e.g. a fixed period of time) from the reception of the clock fail signal CKFAIL. A detailed configuration and operation of the clock generator 140 will be described below.

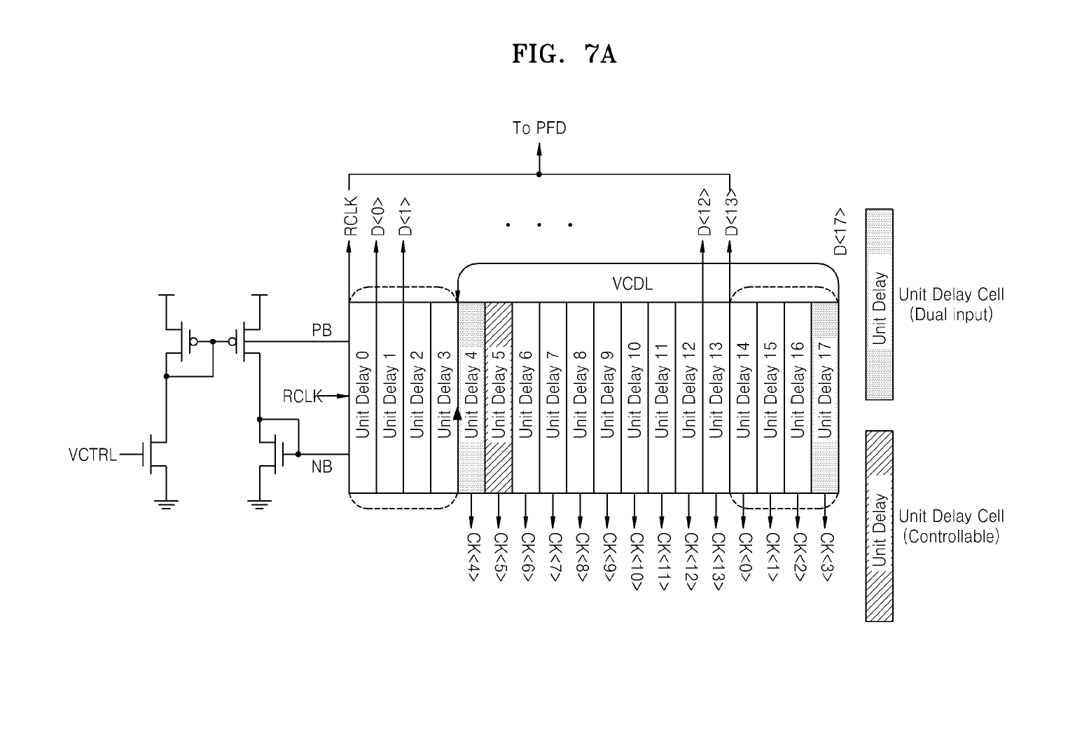

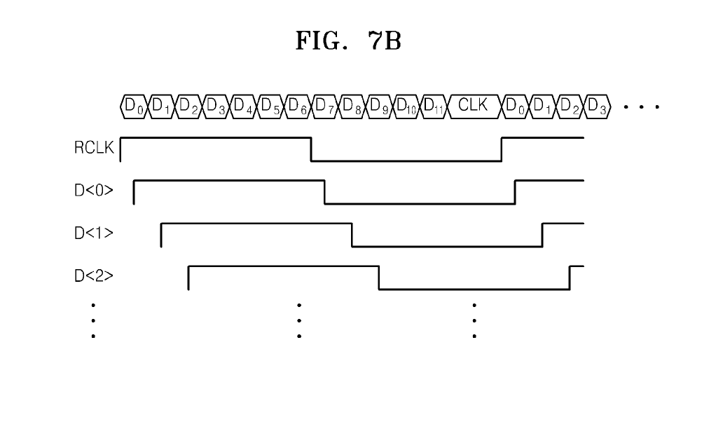

The phase frequency detector 120 may compare the recovery clock signal RCLK with any one delay clock signal (for example, D<13> of FIG. 7A). The phase frequency detector 120 may generate voltage adjusting signals UP and DN depending on a phase difference between the recovery clock signal RCLK and any one delay clock signal (for example, D<13> of FIG. 7).

The control voltage generator 130 may receive the voltage adjusting signals UP and DN to generate a control voltage VCTRL through a charge pump and a loop filter. The control voltage generator 130 may receive the voltage adjusting signals UP and DN to generate the control voltage VCTRL for adjusting the degree of delay in a delay line included in the clock generator 140.

The clock generator 140 may generate the delay clock signals CK<0:N−1> by delaying the recovery clock signal RCLK in a normal mode (hereinafter, referred to as a first mode) in which noise is not inserted in the recovery clock signal RCLK. The clock generator 140 may generate the delay clock signals CK<0:N−1> through an internal loop in an abnormal mode (hereinafter, referred to as a second mode) in which noise is inserted in the recovery clock signal RCLK.

That is, the clock generator 140 may delay the previously generated delay clock signal CK to generate the delay clock signals CK<0N−1> in the second mode. Specifically, the clock generator 140 operating in the second mode may delay again one of the previously generated delay clock signals CK in the first mode, or may delay again one of the previously generated delay clock signals CK in the second mode, thereby generating the delay clock signal.

The clock generator 140 may switch the first mode to the second mode in response to the clock fail signal CKFAIL.

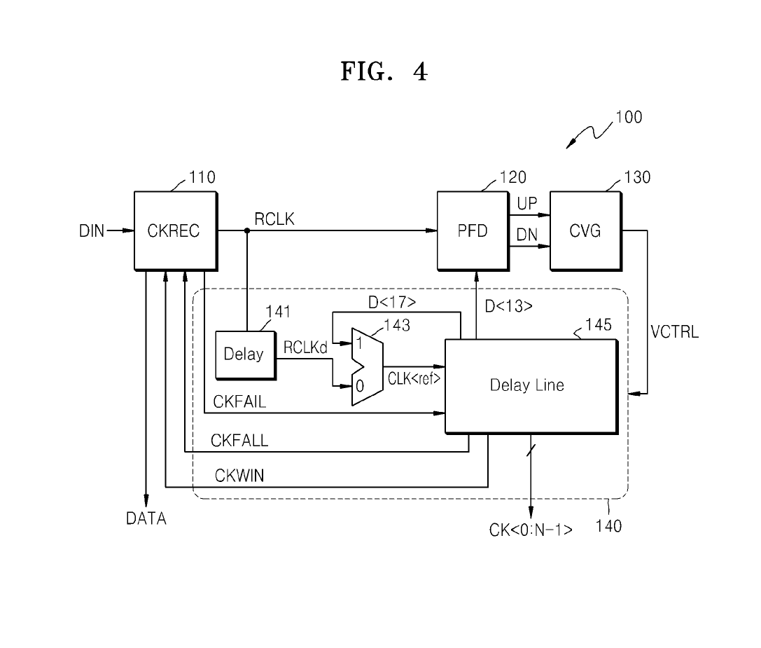

Accordingly, the clock data recovery device 100 may delay the recovery clock signal RCLK to generate the delay clock signals CK<0:N−1> in the first mode, thereby promoting stability which is an advantage of a clock data recovery device having a general voltage controlled data line (VCDL) structure. On the other hand, the clock data recovery device 100 generates the delay clock signals CK<0:N−1> through the internal loop in the second mode in which noise is inserted, and thus the clock data recovery device may not be susceptible to noise. The detailed description thereof will be given below with reference to FIGS. 4 to 10.

The clock recovery device 110, the phase frequency detector 120 and/or the control voltage generator 130 may include an application processor (AP), a microprocessor, a central processing unit (CPU), an application-specific integrated circuit (ASIC), a mobile system on Chip (SoC), a multimedia SoC, a device similar thereto, or a system similar thereto.

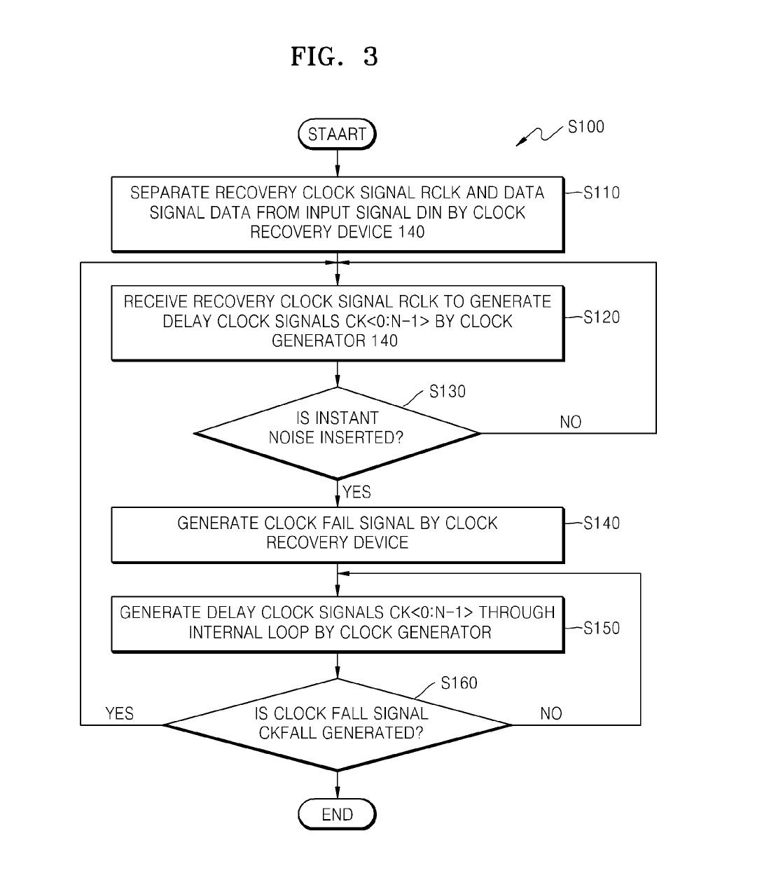

FIG. 3 is a flowchart illustrating an operation of the clock data recovery device 100 of FIG. 2.

Referring to FIG. 3, in an operation S100 of the clock data recovery device 100, the clock recovery device 110 may receive the input signal DIN and separate the recovery clock signal RCLK and the data signal DATA that are serially included in the input signal DIN (operation S110). In the first mode, the clock generator 140 may receive the recovery clock signal RCLK to generate the delay clock signals CK<0:N−1> (operation S120). When instant noise is inserted into the input signal DIN, the clock recovery device 110 may generate the clock fail signal CKFAIL (operations S130 and S140). The clock generator 140 may receive the clock fail signal CKFAIL and switch the first mode to the second mode. In the second mode, the clock generator 140 may generate the delay clock signals CK<0:N−1> through the internal loop (operation S150). The clock generator 140 may generate the clock fall signal CKFALL after the elapse of a period of time (operation S160). The clock recovery device 110 having received the clock fall signal CKFALL may generate the recovery clock signal RCLK again. The clock generator 140 may switch the second mode to the first mode.

FIG. 4 is a detailed block diagram of the clock data recovery device 100 of FIG. 2.

Referring to FIG. 4, the clock generator 140 included in the clock data recovery device 100 may include a delay unit 141, a multiplexer 143, and a delay line 145.

The delay unit 141 may delay the recovery clock signal RCLK for a period of time to generate a reference delay clock signal RCLKd. The period of time for which the delay unit 141 delays the recovery clock signal RCLK may vary. The delay unit 141 may be constituted by one or more current starved NAND gates. The delay unit 141 may be configured as a plurality of current starved NAND gates.

The multiplexer 143 may output one of the reference delay clock signal RCLKd and a delay clock signal D<1.7=> (see FIG. 7A) as a reference clock signal CLK<ref> in response to the clock fail signal CKFAIL. When the delay unit 141 is configured as a plurality of current starved NAND gates, the multiplexer 143 may be included in the last NAND gate of the array.

The delay line 145 may output delay clock signals based on whether the multiplexer outputs the reference delay clock signal RCLKd or the delay clock signal D<17>.

For example, when the output from the multiplexer is the reference delay clock signal RCLKd, that is, when the clock generator 140 is operated in the normal (first) mode, the delay line 145 may delay the reference delay clock signal RCLKd to generate the delay clock signals CK<O:N−1>. Further, when the value output from the multiplexer is the delay clock signal D<17>, that is, when the clock generator 140 is operated in the abnormal (second) mode in which noise is inserted, the delay line 145 may delay the delay clock signal D<17> again to generate the delay clock signals CK<0:N−1>.

The delay line 145 may be configured as a plurality of current starved NAND gates.

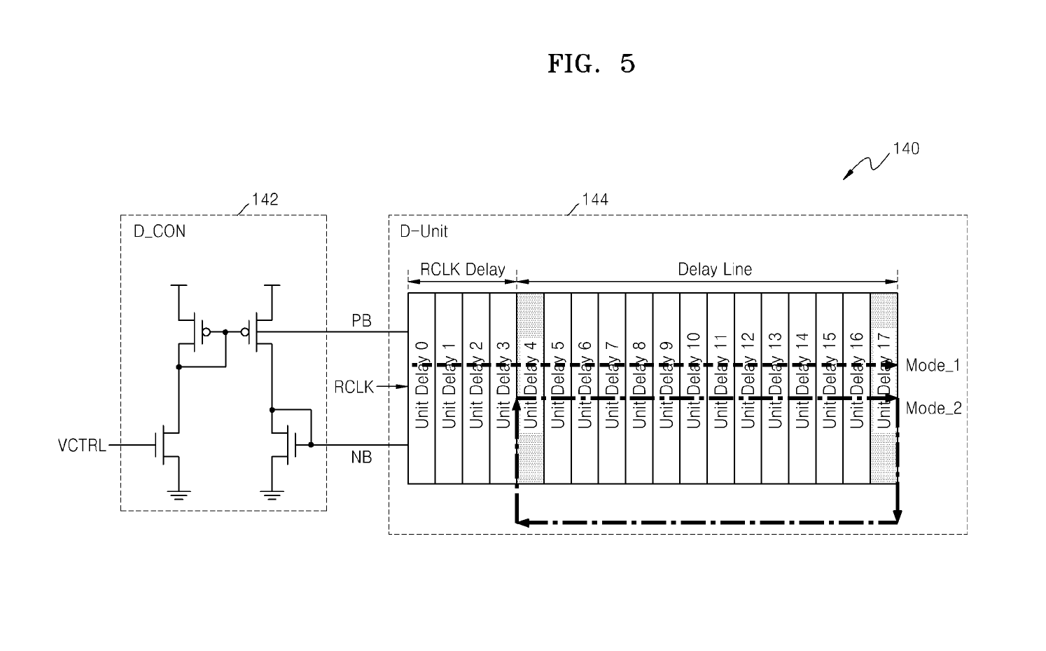

FIG. 5 is a circuit diagram illustrating the clock generator 140 according to an example embodiment of the inventive concepts.

Referring to FIG. 5, the clock generator 140 may include a delay controller D_CON 142 and a delay unit D-Unit 144.

The delay controller 142 may receive the control voltage VCTRL to generate adjusting currents PB and NB that are proportional to the control voltage VCTRL. The circuit diagram of FIG. 5 is configured such that the delay controller 142 generates two adjusting currents PB and NB by a current minor structure. However, the circuit structure of the delay controller 142 may have other configurations. For example, the delay controller 142 may generate a single adjusting signal.

The delay unit 144 may include a plurality of unit delays 0 to 17. Although it is illustrated in FIG. 5 that the delay unit 144 includes eighteen unit delays, example embodiments are not limited thereto. In addition, it is illustrated that a delay clock signal passing through fourteen unit delays has the same phase as that of a reference delay clock signal after one cycle, but example embodiments are not limited to this particular number of unit delays.

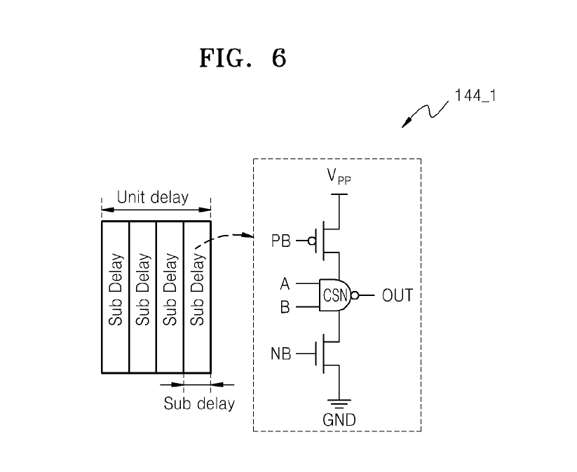

FIG. 6 is a diagram illustrating a unit delay 144_1 included in the clock generator 140 according to an example embodiment of the inventive concepts.

Referring to FIG. 6, the unit delay 144_1 included in the delay unit 144 may include a plurality of sub delays. Although it is illustrated in FIG. 6 that one unit delay includes four sub delays, example embodiments are not limited thereto and the unit delay may include various numbers of sub delays.

Each of the sub delays may include two transistors and one current starved NAND gate. The two transistors may be connected to a power supply voltage Vpp and a ground voltage GND. The sub delay may receive the adjusting currents PB and NB as inputs and adjust a delay time for which a delay by a current starved NAND gate CSN occurs.

The current starved NAND gate CSN may receive two signals A and B as inputs. For example, the current starved NAND gate CSN may receive the recovery clock signal RCLK (A) as one input and receive the power supply voltage Vpp (B) as the other input, and thus may operate like, for example, a current starved inverter which delays the recovery clock signal RCLK. In this case, the current starved NAND gate CSN may delay the recovery clock signal RCLK to generate an output signal OUT.

On the other hand, a NAND gate of another sub delay (unit delay) may receive a control signal instead of the power supply voltage Vpp and adjust the output signal OUT. The detailed description thereof will be given below.

Referring back to FIG. 5, the delay unit 144 receives the recovery clock signal RCLK as an input and passes through each unit delay to generate a signal which is delayed for a unit delay time UI. For example, a signal passing through four unit delay units (e.g., Unit delay 0 to Unit delay 3) may be a signal in which the recovery clock signal RCLK is delayed for 4UI. In addition, for example, a signal passing through seventeen unit delays (e.g. Unit delay 0 to Unit Delay 16) may be a signal in which the recovery clock signal RCLK is delayed for 17UI.

In the first mode, the delay unit 144 may sequentially delay the recovery clock signal RCLK to generate a plurality of delay clock signals CK<0:N−1> as outputs of unit delays (Unit Delay 4 to Unit Delay 17).

Specifically, the recovery clock signal RCLK may pass through a first delay (Unit Delay 0) to generate a delay clock signal CK<0>. The recovery clock signal RCLK may pass through the first delay (Unit Delay 0) and a second delay (Unit Delay 1) to generate a delay clock signal CK<1>. The recovery clock signal RCLK may pass through the unit delay (Unit Delay 0) to a unit delay (Unit Delay 2) to generate a delay clock signal CK<2>.

Subsequently, the recovery clock signal RCLK may pass through the unit delay (Unit Delay 0) to a unit delay (Unit Delay 3) to generate a delay clock signal CK<3> and so on. Finally, the recovery clock signal RCLK may pass through the unit delay (Unit Delay 0) to a unit delay (Unit Delay 13) to generate a delay clock signal CK<13>.

In the first mode in which noise is not inserted, a delay clock signal CK<0:N−1> may be continuously generated in this manner. The delay clock signal CK<−13> is generated in the first mode until a period corresponding to the moment at which noise is inserted in the first mode. For example, when noise is generated in a delay clock signal CK<9> of the first mode, the delay clock signal is generated in the first mode until the delay clock signal CK<13>.

On the other hand, in the second mode in which noise is detected, the delay unit 144 feeds back an output of an eighteenth unit delay through an input of a unit delay (Unit Delay 4) and then delays again the output of the eighteenth unit delay (Unit Delay 17) to generate a plurality of delay clock signals CK<0:N−1>.

For example, when the noise is inserted at a time when the delay clock signal CK<13> is generated, the mode is switched from the first mode to the second mode, and thus the recovery clock signal RCLK may generate a signal passing through the unit delay (Unit Delay 0) to a unit delay (Unit Delay 14), as the delay clock signal CK<0>. In addition, the recovery clock signal RCLK may generate a signal passing through the unit delay (Unit Delay 0) to a unit delay (Unit Delay 15), as the delay clock signal CK<1>. In the same manner, the recovery clock signal RCLK may generate a signal passing through the unit delay (Unit Delay 0) a unit delay (Unit Delay 17), as the delay clock signal CK<3>.

Then, the output of the eighteenth unit delay (Unit Delay 17) may be delayed again to generate a plurality of delay clock signals CK<0:N−1>. For example, the output of the eighteenth unit delay (Unit Delay 17) passes through the fifth delay (Unit Delay 4) to generate a clock signal CK<4>. In addition, the output of the eighteenth unit delay (Unit Delay 17) passes through again the fifth delay (Unit Delay 4) and a sixth delay (Unit Delay 5) to generate a delay clock signal CK<6>.

In this manner, delay clock signals may be sequentially generated until noise disappears in the second mode.

The number of unit delays used to generate a reference clock signal CLK<ref> through the recovery clock signal RCLK may vary. In addition, the number of unit delays used to generate a delay clock signals CK<0:N−1> through the reference clock signal CILK<ref> may vary.

Accordingly, the clock data recovery device 100 may promote stability which is an advantage of a clock data recovery device having a general voltage controlled data line VCDL structure in the first mode. On the other hand, the clock data recovery device 100 may continuously generate the delay clock signals CK<0:N−1> through the internal loop in the second mode in which noise is inserted, and thus the clock data recovery may not be susceptible to noise. That is, when noise is inserted, a time required to determine whether noise is inserted may be ensured. In addition, when noise is inserted, a clock generator may switch from the first mode to the second mode to generate a clock signal.

FIGS. 7A and 7B are diagrams illustrating signals that are generated by the delay unit 144 of FIG. 5.

Referring to FIG. 7A, when the recovery clock signal RCLK is input to the display unit 144 (see FIG. 5), the recovery clock signal RCLK passes through unit delays (Unit Delay 0 to Unit Delay 17) to generate delay signals D<0> to D<17>, respectively. In the delay signals D<0> to D<17>, the delay signals D<4> tri D<17> are output as clock signals CK<4> to CK<13> and CK<0> to CK<3>.

The recovery clock signal RCLK and the delay clock signal CK<13> may be input to the phase frequency detector 120 and may be compared with each other. However, the delay clock signal that is compared with the recovery clock signal RCLK is not limited to the delay clock signal CK<13> and different delay clock signals may be compared with the recovery clock signal RCLK in order to adjust a delay time in the unit delay.

Referring to FIG. 7B, the delay signals D<0> to D<2> generated through the recovery clock signal RCLK are illustrated.

The delay unit 144 generates the delay signals D<0> to D<3>, but may not use the delay signals as clock signals but rather the non-delayed clock signals will be used as the clock signals. When noise is inserted, a clock generator may switch the first mode to the second mode to generate a clock signal from the delay signals.

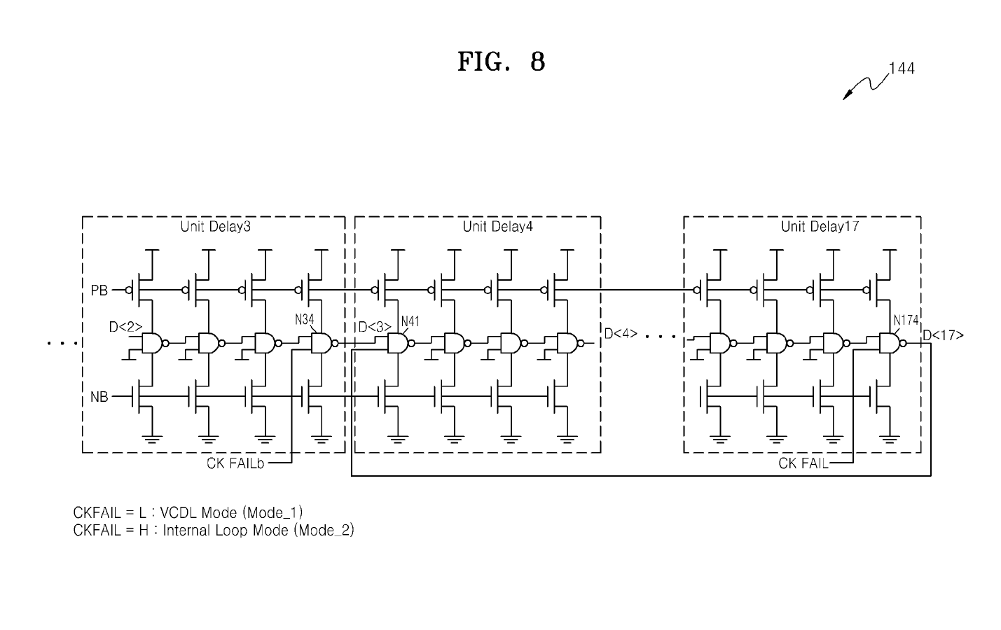

FIG. 8 is a diagram illustrating a mode switching operation of unit delays (Unit Delay 3, Unit Delay 4, and Unit Delay 17) included in the delay unit 144 of FIG. 5.

Referring to FIG. 8, the unit delay (Unit Delay 3) receives a reversed clock fail signal CKFAILb in a NAND gate N34 through an input terminal. In the unit delay (Unit Delay 4), an output signal of a SAID gate N174 is fed back to a NAND gate N41 through an input terminal. A unit delay (Unit Delay 17) receives a clock fail signal QUAIL in a NAND gate N174 through an input terminal.

In the first mode, the reversed clock fail signal CKFAILb is in a logic high level, and thus the NAND gate N34 outputs a fourth delay signal D<3> which is delayed for a unit delay time UI. In addition, since the clock fail signal CKFAIL is in a logic low level, the NAND gate N174 outputs logic high regardless of other input signals.

Accordingly, the NAND gate N41 having the output of the NAND gate N174 being fed back thereto generates an output signal depending on a logic level of the fourth delay signal D<3>. Thus, consequently, the delay unit 144 may sequentially delay the recovery clock signal RCLK to generate delay clock signals.

In the second mode, the reversed clock fail signal CKFAILb is in a logic low level, and thus the NAND gate N34 outputs logic high regardless of other input signals. In addition, since the clock fail signal CKFAIL is in a logic high level, the NAND gate N174 outputs an eighteenth delay signal D<17> in which a seventeenth delay signal D<16> is delayed for a unit delay time UI.

Accordingly, since the NAND gate N41 having received the output of the NAND gate N174 as feedback is in a logic high level, the NAND gate N41 delays the output of the NAND gate N174 to generate an output signal. Thus, consequently, the delay unit 144 may delay again the output of the NAND gate N174 through the internal loop to generate delay clock signals.

FIG. 9 is a timing diagram illustrating an operation of the clock data recovery device 100 according to an example embodiment of the inventive concepts.

Referring to FIGS. 7A and 713 and FIG. 9, the clock recovery device 110 (see FIG. 2) serially receives an input signal DIN. An edge signal EDGE is toggled in response to a portion of a clock signal in the input signal DIN. When a section in which the edge signal EDGE is in a high level is included in a section in which a clock window signal CKWIN is in a high level, a recovery clock signal RCLK is generated. The recovery clock signal RCLK is sequentially delayed to generate delay signals D<0> to D<17>. In addition, the phase frequency detector 120 (see FIG. 2) receives the recovery clock signal RCLK and any one delay clock signal (for example, D<13>) to generate voltage adjusting signals UP and DN. Such an operation is repeatedly continued while the clock data recovery device 100 operates in a first mode.

On the other hand, when instant noise is inserted into the clock data recovery device 100, the edge signal EDGE is not toggled. When the edge signal EDGE is not set to be in a high level in a section in which the clock window signal CKWIN is in a high level, a recovery clock signal is not generated. In addition, when the edge signal EDGE is not set to be in a high level in a section in which the clock window signal CKWIN is in a high state, a logic level of a clock fail signal CKFAIL is changed from low to high.

That is, the clock data recovery device 100 is switched from the first mode to the second mode in response to instant noise. Accordingly, the delay signals D<0> to DK3> are not toggled as in the first mode. Meanwhile, the delay signals D<4> to D<16> are continuously generated in spite of instant noise. In addition, since the recovery clock signal RCLK is not toggled, the voltage adjusting signals UP and DN are not toggled.

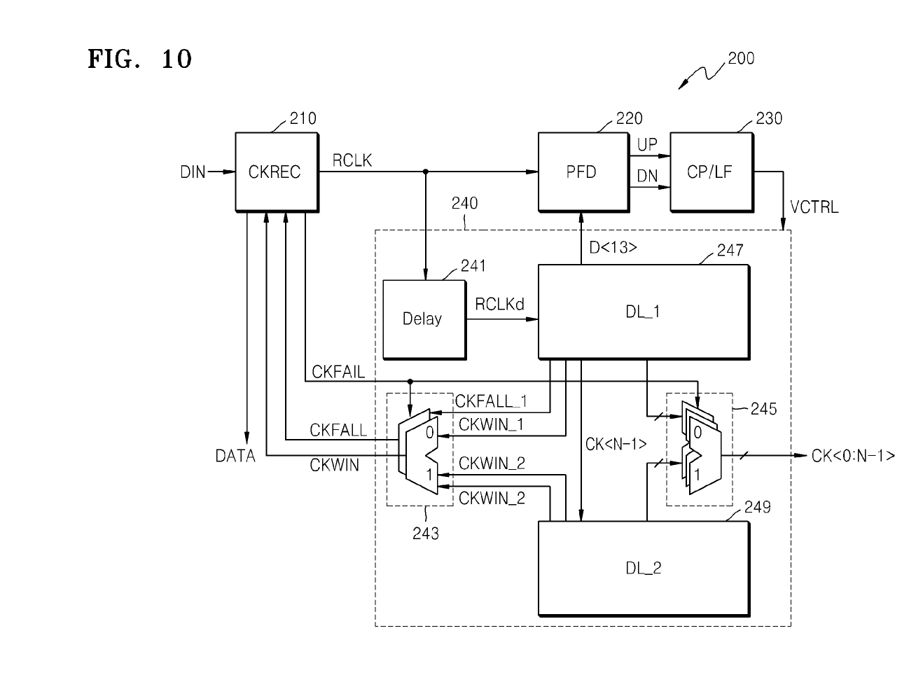

FIG. 10 is a block diagram of a clock data recovery device 200 according to another example embodiment of the inventive concepts.

Referring to FIG. 10, the clock data recovery device 200 may include a clock recovery device 210, a phase frequency detector 220, a control voltage generator 230, and a clock generator 240. The clock recovery device 210, the phase frequency detector 220, and the control voltage generator 230 are operated in a similar manner to the clock recovery device 110, the phase frequency detector 120, and the control voltage generator 130 of FIG. 2.

The clock generator 240 may include a delay unit 241, a plurality of first multiplexers (Multiplexer_{—}1) 243, a plurality of second multiplexers (Multiplexer_{—}2) 245, a first delay line (Delay Line_{—}1) 247, and a second delay line (Delay Line_{—}2) 249.

The clock generator 240 may receive a recovery clock signal RCLK to generate delay clock signals CK<0:N−1>. The clock generator 240 may receive a control voltage to generate a clock window signal, thereby adjusting phases of the delay clock signals CK<0:N−1>. The clock generator 240 may generate a clock fall signal CKFALL after the elapse of a fixed period of time from the reception of a clock fail signal CKFAIL. The clock generator 240 may switch a second mode to a first mode after the elapse of a fixed period of time from the reception of the clock fail signal CKFAIL.

The delay unit 241 may delay the recovery clock signal RCLK for a fixed period of time to generate a reference delay clock signal RCLIKd. The time for which the delay unit 241 delays the recovery clock signal RCLK may vary. The delay unit 241 may be constituted by a current starved NAND gate.

The first multiplexers 243 may output one of a plurality of input signals in response to the clock fail signal CKFAIL. For example, one of the first multiplexers 243 may output one signal of a first clock fall signal CKFALL_{—}1 and a second clock fall signal CKFALL_{—}2. In addition, one of the first multiplexers 243 may output one signal of a first clock window signal CKWIN_{—}1 and a second clock window signal CKWIN_{—}2.

The second multiplexers 245 may select a signal output from a first delay line 247 and a second delay line 249 in response to the clock fail signal CKFAIL. For example, in a first mode, the reference delay clock signal RCLKd may be delayed so as to output delay clock signals CK<0N−1> generated by the first delay line 247 for generating a clock signal. For example, in a second triode, delay clock signals CK<0N−1> generated by the second delay line 249 may be output through an internal loop.

The first delay line 247 may delay the reference delay clock signal RCLKd to generate a clock signal. The second delay line 249 may continuously receive a delay clock signal (for example, CK<N−1>) from the first delay line and then delay the delay clock signal again to generate delay clock signals CK<0:N−1>. The first delay line 247 and the second delay line 249 may be configured as a plurality of current starved NAND gates.

The clock generator 240 may delay the recovery clock signal RCLK in a normal mode (hereinafter, referred to as a first mode) in which noise is not inserted, to generate delay clock signals CK<0:N−1>. The clock generator 240 may generate delay clock signals CK<0:N−1> through an internal loop in an abnormal mode (hereinafter, referred to as a second mode) in which noise is inserted. The clock generator 240 may switch the first mode to the second mode in response to the clock fail signal CKFAIL.

Accordingly, the clock data recovery device 200 may delay the recovery clock signal RCLK to generate the delay clock signals CK<0N−1> in the first mode, thereby promoting stability which is an advantage of a clock data recovery device having a general voltage controlled data line VCDL structure. On the other hand, the clock data recovery device 200 generates the delay clock signals CK<0:N−1> through the internal loop in the second mode in which noise is inserted, and thus the clock data recovery device may not be susceptible to noise.

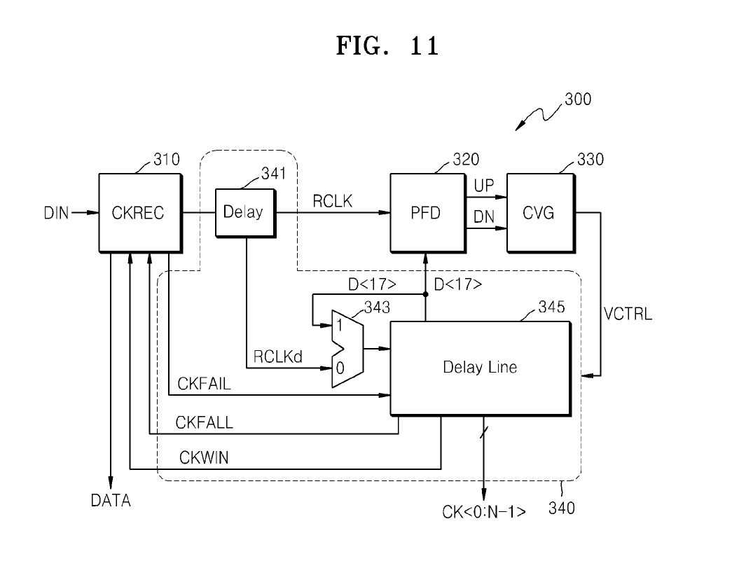

FIG. 11 is a block diagram of a clock data recovery device 300 according to another example embodiment of the inventive concepts.

Referring to FIG. 11, the clock data recovery device 300 may include a clock recovery device 310, a phase frequency detector 320, a control voltage generator 330, and a clock generator 340.

The clock generator 340 may include a delay unit 341, a multiplexer 343, and a delay line 345. The multiplexer 343 and the delay line 345 may be operated in a similar manner to the multiplexer 143 and the delay line 145 of FIG. 4, and thus a repeated description will be omitted.

The delay unit 341 may delay a recovery clock signal RCLK for a fixed period of time to generate a reference delay clock signal RCLKd. The phase frequency detector 320 may compare the reference delay dock signal RCLKd with nay one delay clock signal (for example, D<:17> of FIG. 7A). The phase frequency detector 120 may generate voltage adjusting signals UP and DN depending on a phase difference between the reference delay clock signal RCLKd and the one delay clock signal (for example, D<13> of FIG. 7A). That is, the phase frequency detector 320 nay use the reference delay clock signal RCLKd to generate the voltage adjusting signals UP and DN, unlike the phase frequency detector 120 of FIG. 4.

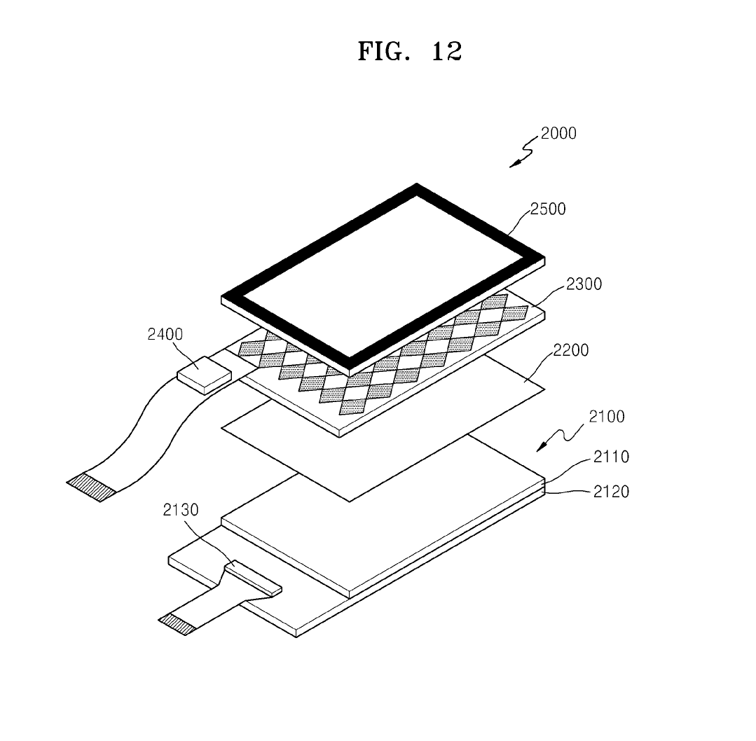

FIG. 12 is a diagram illustrating a display module 2000 according to an example embodiment of the inventive concepts.

Referring to FIG. 12, a display module 2000 may include a display device 2100, a polarizing plate 2200, and a window glass 2300. The display device 2100 includes a display panel 2110, a printed board 2120, and a display driving chip 2130.

The window glass 2300 is generally formed of a material such as acryl or tempered glass so that the display module 2000 is protected against an external impact or scratch due to repetitive touching operations. The polarizing plate 2200 may be provided in order to increase an optical characteristic of the display panel 2110. The display panel 2110 is formed by patterning a transparent electrode on the printed board 2120. The display panel 2110 includes a plurality of pixel cells for displaying a frame. The display panel 2110 may be an organic light-emitting diode panel. Each of the pixel cells includes an organic light-emitting diode that emits light in response to the flow of a current. However, the inventive concepts are not limited thereto. The display panel 2110 may include various types of display devices. For example, the display panel 2110 may be one of a liquid crystal display (LCD), an electrochromic display (ECD), a digital mirror device (DIVED), an actuated mirror device (AMD), a grating light value (GLV), a plasma display panel (PDP), an electro luminescent display (ELD), a light emitting diode (LED) display, and a vacuum fluorescent display (VFD).

The display driving chip 2130 may include the timing controller 11, the data driver 12, and the gate driver 13 of FIG. 1. While the display driving chip 2130 is illustrated as one chip, example embodiments are not limited thereto. For example, a plurality of driving chips may be installed. In addition, the display driving chip 2130 may be mounted in the form of chip on glass (COG) on the printed board 2120 formed of a glass material. However, this is merely an example, and the display driving chip 2130 may be mounted in various forms such as chip on film (COF) or chip on board (COB).

The display module 2000 may further include a touch panel 2500 and a touch controller 2400. The touch panel 2500 may be formed by patterning a transparent electrode such as indium tin oxide (ITO) on a glass substrate or a polyethylene terephthlate (PET) film. The touch controller 2400 senses a touch occurring on the touch panel 2500, calculates a touch coordinate, and transmits the touch coordinate to a host (not shown). The touch controller 2400 and the display driving chip 2130 may be integrated into one semiconductor chip.

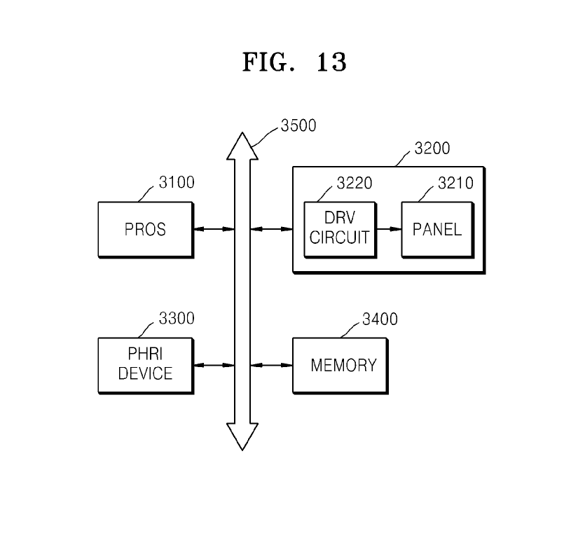

FIG. 13 is a diagram illustrating a display system according to an example embodiment of the inventive concepts.

Referring to FIG. 13, a display system may include a processor (PROS) 3100, a display device 3200, a peripheral (PHRI) device 3300, and a memory 3400 that are electrically connected to a system bus 3500.

The processor 3100 may control inputting and outputting of data of the peripheral device 3300, the memory 3400, and the display device 3200 and perform image processing of image data transmitted between the devices.

The display device 3200 includes a panel 3210 and a driving (DRV) circuit 3220. The display device 3200 may store pieces of image data applied through the system bus 3500 in a frame memory included in the driving circuit 3220 and display the image data on the panel 3210. The display device 3200 may be the display device 10 of FIG. 1.

The peripheral device 3300 may be a device, such as a camera, a scanner, or a webcam, which converts a moving image or a still image into an electrical signal. Image data obtained using the peripheral device 3300 may be stored in the memory 3400, or may be displayed on a panel of the display device 3200 in real time.

The memory 3400 may include a volatile memory device such as a DRAM and/or a non-volatile memory device such as a flash memory. The memory 3400 may be constituted by a DRAM, a PRAM, an MRAM, a ReRAM, a FRAM, a NOR flash memory, a NAND flash memory, a fusion flash memory (for example, a memory in which an SRAM buffer, a NAND flash memory, and a NOR interface logic are combined with each other), or the like. The memory 3400 may store image data obtained from the peripheral device 3300 or store an image signal processed by the processor 3100.

The display system 3000 according to example embodiments of the inventive concepts may be included in a mobile electronic product such as a smart phone. However, the inventive concepts are not limited thereto. For example, the display system 3000 may be included in various types of electronic products that display an image.

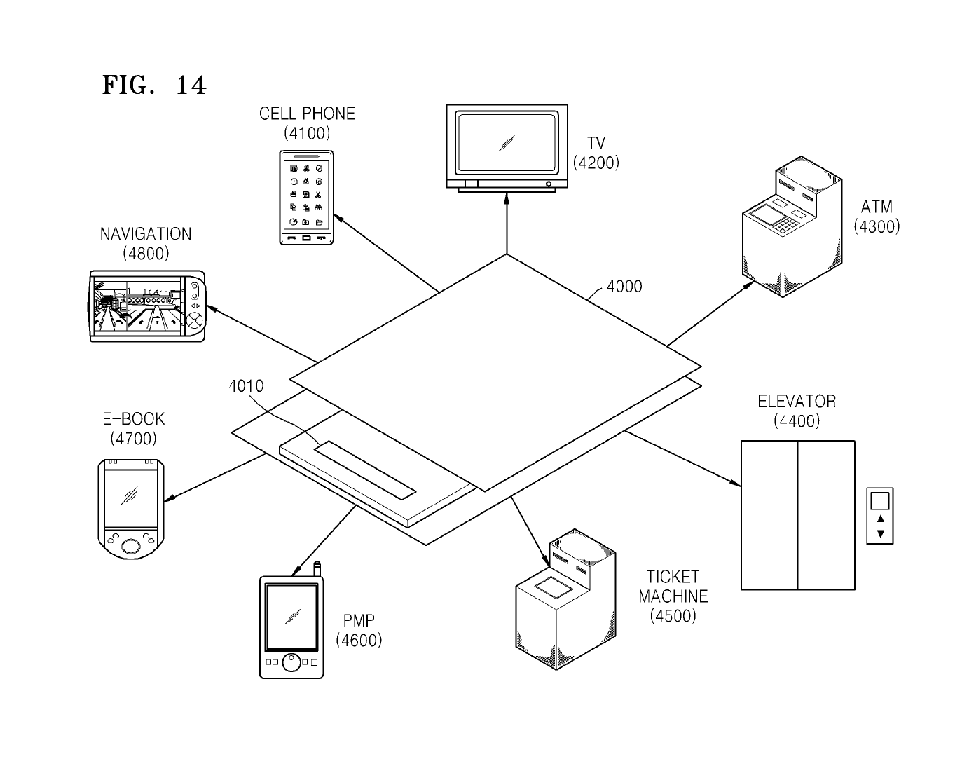

FIG. 14 is a diagram illustrating an application example of various electronic products to which a display device according to an example embodiment of the inventive concepts is mounted.

The display device 4000 according to example embodiments of the inventive concepts may be employed in various electronic products. For example, the display device 4000 may also be employed in a cell phone 4100, and may be widely used in a television (TV) 4200, an Automated Teller Machine (ATM) 4300 which allows users to take out money from their bank account, an elevator 4400, a ticket issuing machine 4500 which is installed in a subway station, a PMP 4600, an e-book 4700, a navigation 4800, and the like. The display device 4000 according to example embodiments of the inventive concepts may be operated in asynchronous with a process of a system. Accordingly, the processor may be operated with a low power and at a high speed by reducing the driving burden of the processor, thereby improving the functions of electronic products.

While the inventive concepts have been particularly shown and described with reference to example embodiments thereof, it will be understood that various changes in form and details may be made therein without departing from the spirit and scope of the following claims.

What is claimed is:

1. A clock data recovery device comprising:
a clock recovery device configured to,
separate a recovery clock signal and a data signal from an input signal, and
generate a clock fail signal in response to noise associated with the input signal;
a clock generator configured to receive a control voltage and generate one or more delay clock signals by,
delaying the recovery clock signal to generate the delay clock signals if the clock generator is in a first mode, and
delaying the delay clock signals generated in the first mode to generate the delay clock signal if the clock generator is in a second mode, the clock generator configured to switch from the first mode to the second mode in response to the clock fail signal;
a phase frequency detector configured to compare at least one of the delay clock signals with the recovery clock signal to generate a voltage adjusting signal; and
a control voltage generator configured to receive the voltage adjusting signal to generate the control voltage.

2. The clock data recovery device of claim 1, wherein the clock generator comprises:
a delay unit configured to delay the recovery clock signal to generate a reference delay clock signal;
a multiplexer configured to output one of the delay clock signals or the reference delay clock signal as a reference clock signal, in response to the clock fail signal; and
a delay line configured to output the delay clock signals on the basis of the reference clock signal.

3. The clock data recovery device of claim 1, wherein the clock generator comprises:
a delay unit configured to delay the recovery clock signal to generate a reference delay clock signal;
a first delay line configured to delay the reference delay clock signal to output output first preliminary delay clock signals; and
a second delay line configured to delay one of the first preliminary delay clock signals to output second preliminary delay clock signals, and
the clock data recovery device further includes,
a multiplexer configured to output the first preliminary delay clock signals or second preliminary delay clock signals in response to the clock fail signal.

4. The clock data recovery device of claim wherein the clock recovery device is configured to generate the clock fail signal based on the clock window signal generated by the clock generator.

5. The clock data recovery device of claim 1, wherein the clock generator is configured to generate a clock fall signal after a period of time from the reception of the clock fail signal, and
the clock recovery is configured to toggle the clock fail signal in response to the clock fall signal.

6. The clock data recovery device of claim 5, wherein at least one of the delay unit, the multiplexer, and the delay line includes at least one delay cell that includes a NAND gate.

7. The clock data recovery device of claim 1, wherein the clock generator comprises:
a plurality of delay cells that include a NAND gate.

8. The clock data recovery device of claim 7, wherein the delay clock signals are output from one or more of the plurality of delay cells.

9. The clock data recovery device of claim 7, wherein an input of the NAND gate included in the plurality of delay cells an inverse of the clock fail signal.

10. The clock data recovery device of claim 7, wherein the clock fail signal is received through one of input terminals of the NAND gate included in a last delay cell of the plurality of delay cells.

11. The clock data recovery device of claim 7, wherein an output terminal of the NAND gate included in a last delay cell of the plurality of delay cells is connected to an input terminal of the NAND gate included in a preceding one of the plurality of delay cells.

12. The clock data recovery device of claim 1, wherein the control voltage generator comprises:
a charge pump configured to receive the voltage adjusting signal and compare the at least one delay clock signal and the recovery clock signal; and
a loop filter configured to generate the control voltage through a difference value between the at least one delay clock signal and the recovery clock signal.

13. A display device comprising:
a timing controller configured to integrate a color data signal and clock signal to generate an input signal;
a display panel configured to output an image based on a gradation voltage; and
a data driver configured generate the gradation voltage from the input signal based on the color data signal and the clock signal included in the input signal, the color data signal and the clock signal being recovered from the input signal using a clock data recovery device, the clock data recovery device including,
a clock recovery device configured to separate a recovery clock signal and a data signal from an input signal and generate a clock fail signal in response to noise associated with the input signal,
a clock generator configured to receive a control voltage and generate one or more delay clock signals by,
delaying the recovery clock signal to generate the delay clock signals if the clock generator is in a first mode, and
delaying the delay clock signal generated in the first mode to generate the delay clock signal if the clock generator is in a second mode, the clock generator configured to switch from the first mode to the second mode in response to the clock fail signal, and
a phase frequency detector configured to compare at least one of the delay clock signals with the recovery clock signal to generate a voltage adjusting signal; and
a control voltage generator configured to receive the voltage adjusting signal to generate the control voltage.

14. The display device of claim 13, wherein the clock generator comprises:
a delay unit configured to delay the recovery clock signal to generate a reference delay clock signal;
a multiplexer configured to output one of the delay clock signals or the reference delay clock signal as a reference clock signal, in response to the clock fail signal; and
a delay line configured to output the delay clock signals on the basis of the reference clock signal.

15. The display device of claim 13, wherein the clock generator comprises:
a plurality of delay cells that include a NAND gate.

16. A clock data recovery device comprising:
a clock recovery device configured to detect noise associated with an input signal and output a clock fail signal based on a result of the detection;
a clock generator configured to recover a clock signal by continuously feeding back a delayed clock signal in an internal feedback loop therein, if the clock fail signal indicates that the clock recovery device detects the noise;
a delay unit configured to delay the clock signal to generate a reference clock signal;
a multiplexer configured to output one of the clock signal and the reference clock signal; and
a delay circuit configured to generate the delayed clock signal by delaying the clock signal based on the reference clock signal, the delay circuit including a plurality of delay cells each including a NAND gate configured to output the delayed clock signal to a first input of a NAND gate in a next one of the plurality of delay cells, the NAND gates having a delay associated therewith, wherein
a second input of the NAND gate in the plurality of delay cells is configured to receive the clock fail signal, and
the NAND gate in a last one of the plurality of delay cells is configured to provide an output thereof to a preceding one of the plurality of delay cells to create the internal feedback loop.

17. The clock data recovery device of claim 16, wherein the clock recovery device is further configured to separate the input signal into the clock signal and a data signal and detect the noise if a signal indicating a rising edge or falling edge of the clock signal does not toggle when the data signal is active, and
the clock data recovery device further comprises:
a phase frequency detector configured to compare at least one of the delayed clock signals with the clock signal and generate an adjusting voltage based on a result of the comparison, an amount of delay included in the delayed clock signal varying based on the adjusting voltage.

18. The clock data recovery device of claim 16, wherein the delayed clock signal is only utilized as the clock signal when the clock generator switches from a first mode to a second mode in response to the clock recovery device detecting the noise associated with the input signal.
